(19) United States
(12) Patent Application Publication
(10) Pub. No.: US 2011/0276392 A1
(43) Pub. Date: Nov. 10, 2011

(54) Performing Geography-Based Advertising Experiments

(75) Inventors: Jon Vaver, Lafayette, CO (US); James R. Koehler, Boulder, CO (US)

(73) Assignee: GOOGLE INC., Mountain View, CA (US)

(21) Appl. No.: 12/777,035

(22) Filed: May 10, 2010

(51) Int. Cl. G06Q 30/00; G06Q 10/00

(52) U.S. Cl. 705/14.43; 705/14.46

(57) ABSTRACT

Methods, systems, and apparatus, including computer programs encoded on computer storage media, for performing geography-based advertising experiments. One method includes receiving pre-spend data for geographic regions, identifying the geographic regions as control or treatment regions, obtaining change in ad spend data for each region, estimating a variance in a return on ad spend according to the pre-spend and the change in ad spend data. The method further includes determining whether the variance satisfies an acceptance criterion, and either allocating the change in ad spend data for use in an advertising experiment or selecting different change in ad spend data. Another method includes receiving pre-spend data for geographic regions, determining a change in ad spend for each geographic region, fitting a model to the pre-spend data, the change in ad spend, and test data, and determining a return on ad spend from the fitted model.

### BACKGROUND

This specification relates to geography-based advertising experiments.

Conventional geography-based advertising experiments label subjects as control subjects and treatment subjects according to where the subjects live. Control subjects are subjects living in geographic regions selected to be control geographic regions and treatment subjects are subjects living in geographic regions selected to be treatment geographic regions. Treatment subjects are exposed to advertisements from an advertising campaign, and control subjects are not exposed to the advertisements. A subject is exposed to an advertising campaign, for example, when an advertisement in the advertising campaign is displayed on a computer viewed by the subject, on a television being viewed by the subject, or on a billboard viewed by a subject. The difference in exposure for control and treatment subjects is maintained, for example, by only displaying advertisements in the advertising campaign on computers having an IP address that is believed to be associated with one of the treatment regions, only displaying the advertisements in television broadcasts directed to the treatment regions, or only presenting the advertisements on billboards physically located within the boundaries of the treatment geographic regions.

Conventional geography-based advertising experiments compare the behavior of treatment subjects to the behavior of control subjects to determine the effect that viewing the advertisements in the advertising campaign has on subject behavior. Example subject behaviors include purchases of products advertised by the campaign or purchases of products related to, but not directly advertised by the campaign. Products can be related when they are in the same field, e.g., both relating to dental care, or when they are both sold by the same store. For example, if a store sold apples and a particular brand of tires, the apples and brand of tires could be related. These purchases can be made in physical stores or online. Another example subject behavior is visiting a website associated with the advertising campaign.

However, the amount of money spent on advertising during an experiment is often small compared to the volume of related user behavior. For example, the sales made during the time that an advertising campaign is being tested are generally much larger (by several orders of magnitude) than the amount spent on the advertising campaign itself. This means that the level of noise in user behavior can make it difficult to determine the true effect of an advertising campaign by merely comparing the behavior of treatment and control subjects. In addition, heterogeneity in geographic entities can also make it difficult to determine the true effect of an advertising campaign by merely comparing the behavior of treatment and control subjects.

### SUMMARY

In general, one innovative aspect of the subject matter described in this specification can be embodied in methods that include the actions of receiving pre-spend data for an experiment for an advertising campaign, the pre-spend data specifying, for each of a plurality of geographic regions, a quantification of an action of interest related to the advertising campaign in the geographic region during a pre-spend period of time; identifying one or more of the geographic regions as first control geographic regions and one or more of the geographic regions as first treatment geographic regions according to a first determination algorithm; obtaining first change in ad spend data for a test period of time, the first change in ad spend data specifying an estimated first change in ad spend for each of the geographic regions, wherein the estimated first change in ad spend is a difference in ad spend in the geographic region during a test period of time occurring after the pre-spend period of time and ad spend in the geographic region during the pre-spend period of time, wherein the estimated first change in ad spend is determined according to a first change in ad spend policy for each first control geographic region and the estimated first change in ad spend is determined according to a different second change in ad spend policy for each first treatment geographic region; estimating a first variance in a return on ad spend for the experiment according to the pre-spend data and the first change in ad spend data, wherein the first variance is estimated from a variance of the first change in ad spend data and a correlation between the pre-spend data and the first change in ad spend data; and determining whether the first variance satisfies an acceptance criterion, allocating the first change in ad spend data for use in an advertising experiment if the first variance satisfies an acceptance criterion, and otherwise selecting different change in ad spend data for use in the advertising experiment. Other embodiments of this aspect include corresponding systems, apparatus, and computer programs recorded on computer storage devices, each configured to perform the operations of the methods.

These and other embodiments can each optionally include one or more of the following features. The acceptance criterion is satisfied if the first variance satisfies a threshold. The actions further include obtaining second change in ad spend data for the test period of time, the second change in ad spend data specifying an estimated second change in ad spend for each of the geographic regions; estimating a second variance in a return on ad spend for the experiment according to the pre-spend data and the second change in ad spend data; and wherein the acceptance criterion is satisfied if the first variance is lower than the second variance. The change in ad spend for each of the treatment geographic regions is derived from the pre-spend data for the region. The change in ad spend is zero for each first control region and the first change in ad spend is non-zero for each first treatment geographic region. The actions further include identifying one or more of the geographic regions as second control geographic regions and one or more of the geographic regions as second treatment geographic regions according to a second determination algorithm; obtaining second change in ad spend data for a test period of time, the second change in ad spend data specifying an estimated second change in ad spend for each of the geographic regions, wherein the estimated second change in ad spend is determined according to a third change in ad spend policy for each second control geographic region and the estimated second change in ad spend is determined according to a different fourth change in ad spend policy for each second treatment geographic region; estimating a second variance in a return on ad spend for the experiment according to the pre-spend data and the second change in ad spend data, wherein the second variance is estimated from a variance of the second ad test data and a correlation between the pre-spend data and the second change in ad spend data; and comparing the first variance to the second variance and selecting the first determination algorithm or the second determination algorithm as a result of the comparison. The first change in ad spend is zero for each first control geographic region, the first change in ad spend is non-zero for each first treatment geographic region, the second change in ad spend is zero for each second control geographic region, and the second change in ad spend is non-zero for each second treatment geographic region.

The actions further include obtaining a length of the experiment, wherein the first variance is further estimated according to the length of the experiment. The quantification of the action of interest in a geographic region is a total amount of revenue earned as a result of sales of a product in the geographic region, wherein the product is a product advertised by the advertising campaign. The quantification of the action of interest in a geographic region is a total amount of revenue earned as a result of sales of a product in the geographic region, wherein the product is a product related to, but not directly advertised by, the advertising campaign. The quantification of the action of interest in a geographic region is a total number of clicks on a website made by subjects in the geographic region.

In general, another innovative aspect of the subject matter described in this specification can be embodied in methods that include the actions of receiving pre-spend data for each of a plurality of geographic regions, the pre-spend data including pre-spend data quantifying an action of interest related to a particular advertising campaign in the geographic region during a pre-spend period of time; identifying one or more of the geographic regions as control geographic regions and one or more of the geographic regions as treatment geographic regions; determining a change in ad spend policy for the particular advertising campaign for each geographic region, wherein the change in ad spend policy specifies how ad spend in the geographic region during a test period of time occurring after the pre-spend period of time should be changed, wherein the change in ad spend policy in each control geographic region is a first change in ad spend policy and the change in ad spend policy in each treatment geographic region is a different second change in ad spend policy; receiving test data for each of the plurality of geographic regions, wherein the test data corresponds to a test period of time during which the particular advertising campaign was run and the test data quantifies the action of interest in the geographic region during the test period of time; determining an experimental change in ad spend for each geographic region, wherein the experimental change in ad spend for a geographic region specifies a difference in an actual ad spend in the geographic region during the test period of time as compared to what the ad spend in the geographic region during the test period of time would have been without the change in ad spend policy for the geographic region; fitting a model to the pre-spend data, the experimental change in ad spend, and the test data, wherein the model models the test data for each geographic region as a function of the pre-spend data and the change in ad spend for each geographic region, and wherein fitting the model includes determining one or more parameters of the function; and determining a return on ad spend from the fitted model. Other embodiments of this aspect include corresponding systems, apparatus, and computer programs recorded on computer storage devices, each configured to perform the operations of the methods.

These and other embodiments can each optionally include one or more of the following features. The change in ad spend is zero in each control geographic region and is non-zero in each treatment geographic region. The model is a linear regression model. The one or more parameters of the function include one or more seasonality parameters and a return on ad spend parameter. One of the one or more seasonality parameters is multiplied by the pre-spend data in the function and the return on ad spend parameter is multiplied by the change in ad spend in the function. The quantification of the action of interest is a quantification of sales of a product advertised by the advertising campaign. The sales of the product are one of in-store sales, online sales, and both in-store sales and online sales. The quantification of the action of interest is a number of clicks on a website associated with the advertising campaign. The actions further include for each geographic region: re-fitting the model using data for each of the plurality of geographic regions except the geographic region, and determining a return on ad spend from the fitted model; determining whether the geographic region is an outlying geographic region from the determined return on ad spend; and re-fitting the model using data for each of the plurality of geographic regions except the geographic regions identified as outlying geographic regions.

Particular embodiments of the subject matter described in this specification can be implemented so as to realize one or more of the following advantages. Effective advertising experiments can be designed. Differences in potential ad spend during an experiment can be objectively evaluated. Differences in lengths of an experiment can be objectively evaluated. Different heuristics used to assign geographic regions to control and treatment groups can be evaluated. A return on ad spend (ROAS) can be estimated for advertising experiments. The noise in subject behavior can be more effectively accounted for. Accurate return on ad spend estimates can be generated. Uncertainty in the estimates can also be determined.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example advertising experiment system.

FIG. 2 illustrates an example timeline for a geography-based advertising experiment.

FIG. 3 is a flow diagram of an example process for collecting and analyzing test data.

FIG. 4 illustrates two example histograms of calculated return on ad spend.

FIG. 5 is a flow diagram of an example process for selecting a change in ad spend.

FIG. 6 is a flow diagram of an example process for selecting a control and treatment region determination heuristic.

FIG. 7 illustrates two example histograms of variance of the β₁ parameter.

Like reference numbers and designations in the various drawings indicate like elements.

### DETAILED DESCRIPTION

### §1.0 Example Geography-Based Experiment System

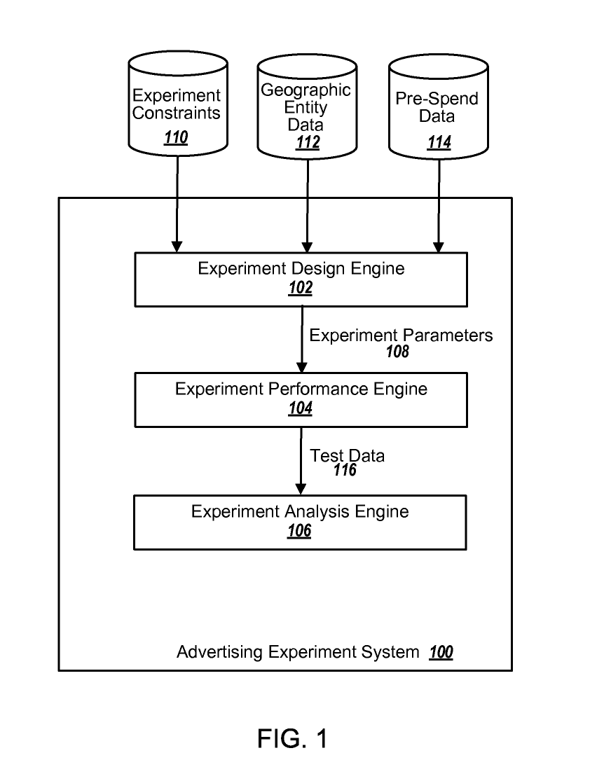

FIG. 1 is a block diagram of an example advertising experiment system 100 that designs and performs advertising experiments and analyzes the results of those advertising experiments. An advertising experiment tests an advertising campaign in geographic regions during a test period of time. Each geographic region is a discrete, non-overlapping, geographic region. The geographic regions can be defined using various heuristics; for example, in some implementations, each geographic region corresponds to a designated market area (DMA).

In general, the advertising experiments are performed by monitoring subject behavior during a pre-spend period and a test period to determine what effect, if any, the increase in ad spend has on user behavior. The test period has two components, a spend period and a post-spend period. During the spend period, the amount of money spent on advertising is changed in treatment geographical regions according to a first change in ad spend policy, and the amount of money spent on advertising is changed in control geographic regions is determined according to a different second change in ad spend policy. Each change in ad spend policy for each region specifies how ad spend in the geographic region during a test period of time occurring after the pre spend period of time should be changed.

In some implementations, the amount of money is increased in the treatment geographic regions and not changed in the control geographic regions. Other policies, for example, policies that decrease the amount of money spent in the treatment geographic regions and do not change the amount of money spent in the control regions, or policies that decrease the amount of money spent in the treatment geographic regions and increase the amount of money spent in the control regions can also be used. In the post-spend period, the amount of money spent on advertising in each region returns to its pre-spend levels. For convenience, test period is used in the description below to refer to both the spend period and the post-spend period, while pre-spend period is used to refer to the period before ad spend is modified in the treatment regions. However, other naming conventions could alternatively be used.

The geography-based experiment system 100 is implemented as one or more software programs executing on one or more computers. The geography-based experiment system 100 includes an experiment design engine 102 that aids in design of an advertising experiment, an experiment performance engine 104 that aids in the performance of the advertising experiment, and an experiment analysis engine 106 that analyzes the data gathered during the experiment. While the advertising experiment system 100 is illustrated as a single system in FIG. 1, the individual components of the advertising experiment system 100 can alternatively be divided among multiple systems.

The experiment design engine 102 selects one or more experiment parameters 108 for the experiment. The experiment parameters can include, for example, a change in ad spend policy in each geographic region during the spend period for the experiment, the length of the test period, which geographic regions are used in the experiment, and which of a possible set of heuristics should be used to designate treatment and control geographic regions.

The experiment design engine 102 selects these parameters according to one or more of experiment constraints 110, geographic region data 112, and pre-spend data 114. The experiment constraints 110 are one or more constraints that specify requirements for the experiment. Example constraints include a maximum acceptable variance in the return on ad spend estimated by the experiment analysis engine 106, a maximum amount of money that can be spent during the experiment, or a maximum length of time for the experiment.

The geographic region data 112 specifies the physical coordinates associated with geographic regions (e.g., the physical coordinates of the boundaries of the geographic region or the physical coordinates of the center of the geographic region). The geographic region data 112 can optionally include other descriptive details for the geographic regions, for example, the population of each geographic region, the volume of internet activity in each geographic region (e.g., a search volume or a volume of visits to particular web sites), and the number of businesses of a particular type that are located within each geographic region.

The pre-spend data 114 specifies, for each geographic region, a quantification of an action of interest taken by subjects in the geographic region during a particular period before the test begins. An action of interest is a subject action hypothesized to be affected by viewing the advertisement. Example actions of interest include, for example, purchasing goods from physical stores, purchasing goods from online stores, purchasing goods from both online and physical stores, clicking on a link to an advertiser's website, otherwise visiting an advertiser's website, opening an account on an advertiser's website, or requesting a quote from an advertiser's website. For example, an advertiser might be interested in how many sales, or how much additional revenue, are generated from an advertisement that would not otherwise take place. In this example, the advertiser can quantify the action of interest as the number of goods sold or the amount of revenue generated from sales. As another example, an advertiser might be interested in knowing how many visits to the advertiser's website that would otherwise not occur are generated by an advertisement. In this example, the advertiser can quantify the action of interest as the number of visits to the advertiser's website.

Example processes for determining the experiment parameters 108 from the experiment constraints 110, the geographic region data 112, and the pre-spend data 114 are described in more detail below in §4.0.

The experiment performance engine 104 receives the experiment parameters 108 and directs an advertising experiment according to the parameters. In some implementations, the experiment performance engine 104 conducts the experiment itself; in other implementations, the experiment performance engine 104 allocates the parameters for use by a separate system that controls what advertisements are shown to what subjects. The experiment performance engine 104 collects test data 116 that specifies for each geographic region, a quantification of an action of interest taken by subjects in the geographic region during the test period. The experiment performance engine 104 provides this test data 116 to the experiment analysis engine 106. Performing the experiment is described in more detail below in §2.0.

The experiment analysis engine 106 analyzes the test data 116, along with the pre-spend data 106 and the change in ad spend for each geographic region to determine a return on ad spend for the advertising campaign. The return on ad spend is an estimated effect that the change in ad spend due to the change in ad spend policy will have on the action of interest. For example, the return on ad spend can correspond to the number of clicks on (e.g., visits to) a website of interest that are determined to be caused by the advertising divided by the amount spent on the advertising. Example methods for analyzing the test data 116 are described in more detail below in §3.0.

§2.0 Performing a Geography-Based Advertising Experiment

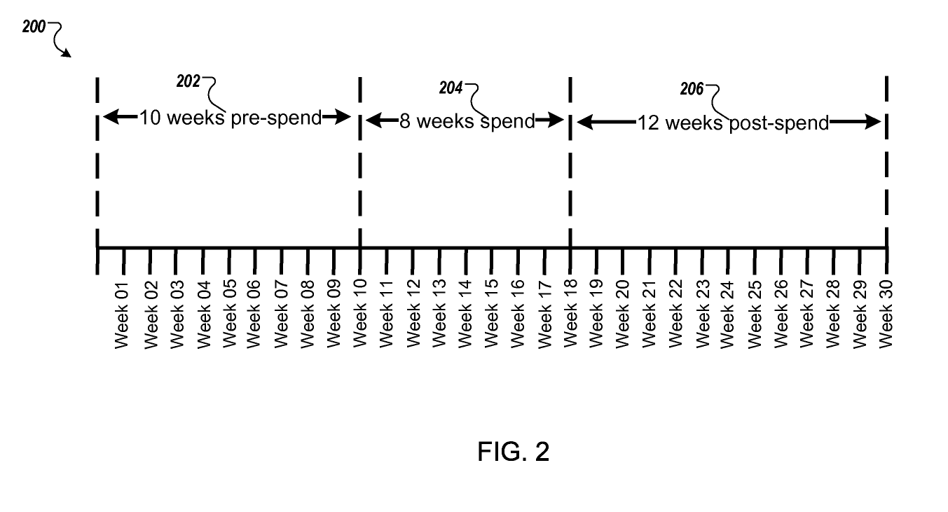

FIG. 2 illustrates an example timeline 200 for a geography-based advertising experiment. The experiment timeline is broken down into three periods, a pre-spend period 202, a spend period 204, and a post-spend period 206. Together, the spend period 204 and the post-spend period 206 make up the test period. During the pre-spend period 202, a baseline amount of money is spent on advertising in all of the geographic regions. For example, this baseline can be 0 in all regions, can be the same non-zero amount in all regions, or can be differing amounts in different regions. During the spend period 204, the amount spent on advertising in each region is changed by the amount specified in the change in ad spend data. The control regions will have a change in ad spend determined according to a first change in ad spend policy, e.g., zero or some other number, and the treatment regions will have a change in ad spend determined according to a different second change in ad spend policy. During the post-spend period 206, the ad spend in each region returns to the pre-spend levels. However, the effect of the changed ad spend during the spend period may still be discernable in subject actions that are taken during the post-spend period.

Pre-spend data is collected for the pre-spend period 202, and test data is collected for the spend period 204 and the post-spend period 206. Both the pre-spend data and the test data describe the behavior of subjects in the treatment regions and subjects in the control regions during the appropriate period (e.g., the pre-spend period or the test period. For example, the system can collect data describing one or more actions of interest, e.g., as represented by sales volume in offline stores, sales volume in online stores, total sales volume, or number of visits to a website associated with the advertisement. In some implementations, the system gathers the data itself. For example, in an online experiment where users are shown online advertisements and the action of interest is a number of clicks on links to a website associated with the experiment, the same system that determines which advertisements should be shown to which users can also record which links users click on. In other implementations, the system receives the data from another system. For example, sales data can be received from the individual stores making sales, or from a company that tracks sales data across one or more of the stores.

§3.0 Performing a Geographic-Based Advertising Experiment

Once the pre-spend and test data are gathered, the system 100 analyzes the pre-spend and test data, along with the change in ad spend, to determine an effect that the increased ad spend has on user behavior. The system 100 can also determine whether one or more of the geographic regions are outlier geographic regions that should not be considered for purposes of the analysis.

§3.1 Example Process for Performing a Geographic-Based Advertising Experiment

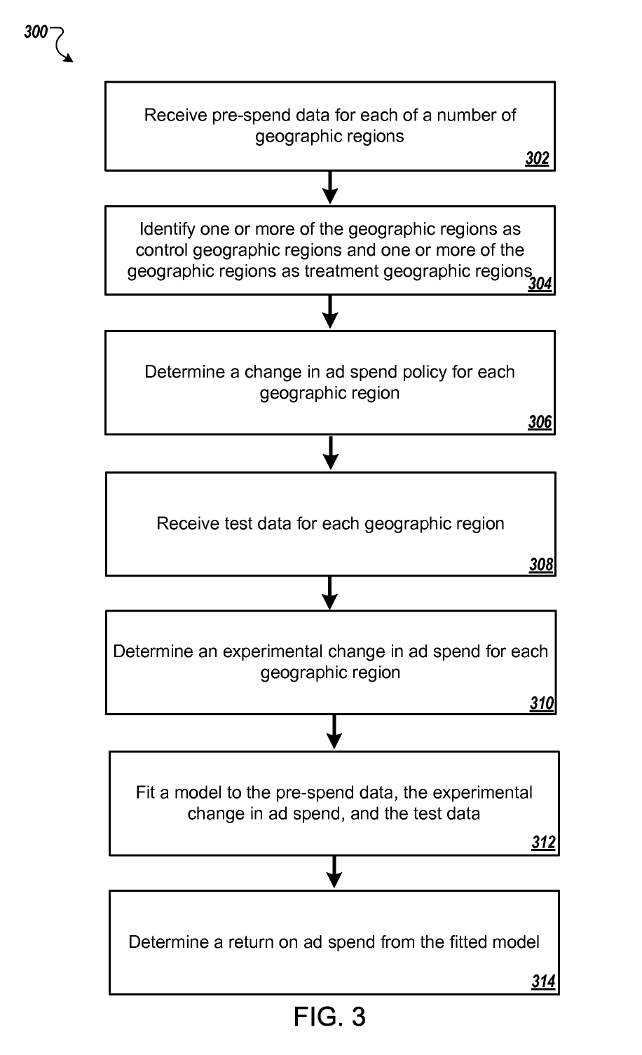

FIG. 3 is a flow diagram of an example process 300 for collecting and analyzing test data to determine the effect of an advertising campaign on an action of interest. The process 300 can be implemented, for example, by the system 100, described above with reference to FIG. 1.

The process 300 receives pre-spend data for each of a number of geographic regions (302), for example, as described above in §1.0. The process 300 identifies one or more of the geographic regions as control geographic regions and one or more of the geographic regions as treatment geographic regions (304). The process 300 identifies the geographic and control regions according to a heuristic. Example heuristics are described in more detail below in §3.2.

The process 300 determines a change in ad spend policy for each geographic region (306). The change in ad spend policy for each region specifies how ad spend in the geographic region during a test period of time occurring after the pre-spend period of time should be changed. The change in ad spend policy in each control geographic region is a first ad spend policy and the change in ad spend policy in each treatment region is a different ad spend policy. In some implementations, the change in ad spend is pre-defined. For example, the ad spend policies can be part of the experiment constraints. Example techniques for selecting an appropriate change in ad spend policy for each region are described in more detail below in §3.1.

The process 300 receives test data for each of the plurality of geographic regions (308). The test data quantifies an action of interest in each of the geographic regions during the test period. The test period corresponds to the period of time for which the experiment is currently being evaluated. In some implementations, the test period includes both the entire spend period and the entire post-spend period. In other implementations, the test period includes a proper subset of the entire spend period and the entire post-spend period, for example, the first two weeks of the spend period or the entire spend period and the first three weeks of the post-spend period. The action of interest is related to the advertising campaign being tested. The test data is gathered, for example, as described above in §2.0.

The system determines an experimental change in ad spend for each geographic region (310). The experimental change in ad spend for a geographic region is a difference in ad spend in the geographic region during the test period of time as compared to what the ad spend in the geographic region would have been during the test period of time without the change in ad spend policy for the geographic region.

In some implementations, the change in ad spend policy for a region specifies a specific amount of money by which to decrease or increase spending in a region, e.g., by specifying a fixed amount or an algorithm for determining the specific amount. In these implementations, the experimental change in ad spend is the specific amount of money specified by the change in ad spend policy.

In other implementations, the change in ad spend policy for a region does not specify a specific amount of money by which to decrease or increase spending in a region. For example, the change in ad spend policy might specify additional keywords for which advertisements will be displayed or a change in the maximum price paid per individual advertisement shown. In these implementations, any observed change in ad spend might be due in part to the change in ad spend policy, and in part to other changes unrelated to the change in ad spend policy. In these implementations, the process 300 calculates the experimental change in ad spend so as to isolate the change due to the change in ad spend policy from general changes in ad spend behavior that are unrelated to the change in ad spend policy.

For example, the process 300 can calculate the experimental change in ad spend as follows. When the change in ad spend policy for the control regions is to not change the ad spend, the process 300 determines that the experimental change in ad spend in each control region is 0. To determine the experimental change in ad spend in each treatment region, the process 300 fits the following linear model to the data for the control regions to solve for seasonality parameters α₀ and α₁:

test spend˜α₀+α₁(pre-test spend),

where test spend is a vector with entries corresponding to the amount spent in each control region during the test and pre-test spend is a vector with entries corresponding to the amount spent in each control region during the pre-test period.

Once the process determines the seasonality parameters α₀ and α₁, the process determines the experimental change in ad spend for each treatment region jas follows:

(change in ad spend)ⱼ=(test spend)ⱼ−α₀−α₁(pre-test spend)ⱼ.

When the change in ad spend policy for the control region and the treatment region both change the ad spend in their respective regions, the process 300 can calculate the experimental change in ad spend in each region as follows. First, the process 300 determines seasonality parameters α₀, α₁, α₂, and α₃ by fitting the following linear model to the data for the control and treatment regions:

$${( test spend )}_{k} ∼ {α}_{0} + {{α}_{1} ( pre \text{-} test spend )}_{k} + {α}_{2} {{I}_{k}^{C} ( pre \text{-} test spend )}_{k} + {α}_{3} {{I}_{k}^{T} ( pre \text{-} test spend )}_{k} ,$$

where (test spend)ₖ and (pre-test spend)ₖ are the test spend and the pre-test spend in each region k, Iₖ^{C} is an indicator variable that is 1 when region k is a control region and 0 when region k is a treatment region, and Ir is an indicator variable that is 1 when region k is a treatment region and 0 when region k is a control region.

Once the process 300 solves for α₀, α₁, α₂, and α₃, the process calculates the experimental change in ad spend in each region as follows:

(change in ad spend)ₖ=(test spend)ₖ−α₀−α₁(pre-test spend)ⱼ.

The process 300 fits a model to the pre-spend data, the experimental change in ad spend, and the test data (312). The model models the test data for each geographic region as a function of the pre-spend data and the change in ad spend for each geographic region. Fitting the model includes determining one or more parameters of the function. The process determines a return on ad spend from the fitted model (312).

In some implementations, the model is a linear regression model. For example, the model can be represented as follows:

(test data)˜β₀+β₁(pre-test data)+β₂(change in ad spena)+ε,

where test data, pre-spend data, and change in ad spend are each vectors with an entry corresponding to the data for each geographic region. Consider an example where two regions (regions A and B) are used in the experiment. Region A has test data of 100, pre-spend data of 50, and experimental change in ad spend of 25 and region B has test data of 60, pre-spend data of 40, and experimental change in ad spend of 0. In this example, the test vector would be (100, 60), the pre test data vector would be (50, 40), and the experimental change in ad spend vector would be (25, 0).

In the model described above, β₀ and β₁ are scalars corresponding to seasonality parameters, β₂ is a scalar corresponding to the return on ad spend, and c is a scalar corresponding to a disturbance term that accounts for the effect of other factors that might influence the test data but are not explicitly included in the model.

The seasonality parameters β₀ and β₁ account for the fact that subject actions may naturally change during different times of the year. For example, if the action of interest is in-store sales, many stores naturally have an increase in sales in December because of the holidays. Therefore, an increase in in-store sales in December will likely be seen in all regions, not just treatment regions, and is not due purely to the advertising campaign.

The return on ad spend β₂ is an estimate of the effect that the ad spend has on subject behavior. For example, if the action of interest is quantified by revenue, the return on ad spend represents revenue generated by the ad spend divided by ad spend. Similarly, if the action of interest is quantified as a number of clicks, the return on ad spend represents the number of clicks generated by the ad spend divided by the ad spend.

In some implementations, the process 300 considers sub-parts of the test period when calculating the return on ad spend. For example, the system can calculate the return on ad spend on a weekly basis, using change in ad spend and test data for a test period corresponding to the cumulative amount of ad spend and the cumulative test data up to the current week for which the return on ad spend is being calculated. This allows the process 300 to track the effect of the changed expenditure on advertising over time, both during the time that the expenditure is changed, and after the expenditure has returned to its pre-spend levels.

§3.2 Example Process for Performing a Geographic-Based Advertising Experiment

In some implementations, after the system 100 analyzes the data to determine a return on ad spend from the fitted model, the system 100 determines whether the quality of the results can be improved, e.g., the variance in the return on ad spend can be reduced, by eliminating one or more outlying geographic regions from the analysis.

The system 100 analyzes each geographic region in turn and re-fits the model using data from all of the geographic regions except the geographic region being analyzed. The system 100 then examines the resulting returns on ad spend to determine whether any of the geographic regions are outliers. A geographic region is an outlier if the return on ad spend calculated without the geographic region differs by more than a threshold amount from the other calculated returns on ad spend. For example, the threshold could be a return on ad spend that is more than the ninety-fifth percentile or less than the fifth percentile of the calculated returns on ad spend. Various factors can cause a geographic region to be an outlier. For example, if new stores are opened in the region or a new product line was expanded in the region, then the region might be an outlier.

The system 100 can repeat the process, using successively smaller numbers of geographic regions as geographic regions are removed. The process is repeated until there are no more outliers, until a pre-determined maximum number of geographic regions have been removed, or until another termination condition is satisfied. The return on ad spend for the remaining geographic regions is used as the return on ad spend for the experiment.

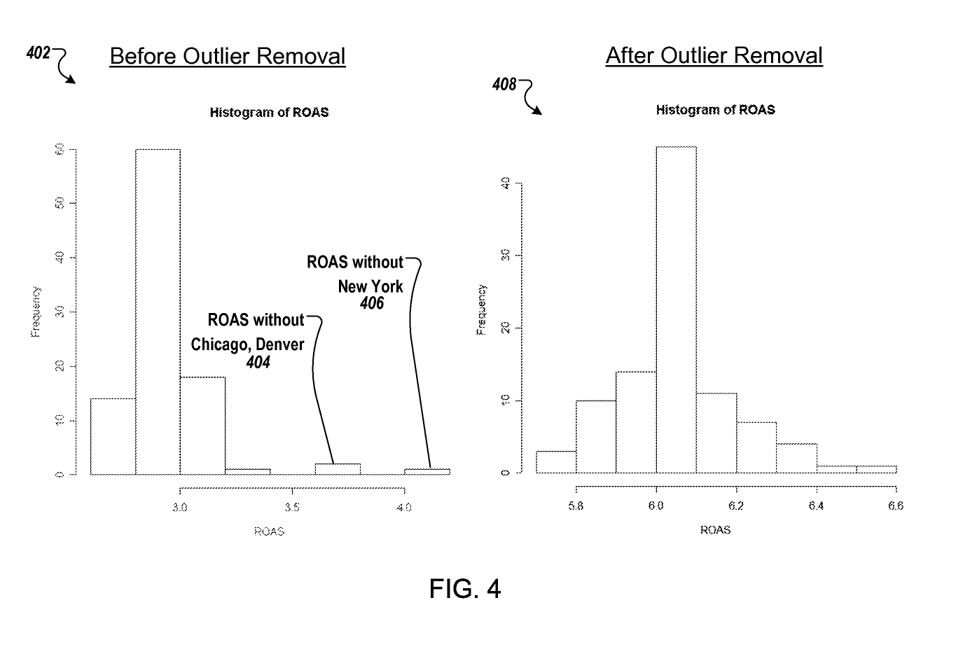

FIG. 4 illustrates two example histograms of the calculated return on ad spend. In histogram 402, the returns on ad spend are plotted, and outlying returns on ad spend, e.g., the returns on ad spend corresponding to the removal of Chicago and Denver 404, respectively, and the return on ad spend corresponding to the removal of New York 406 are identified. Chicago, Denver, and New York are each identified as outlying geographic regions because the return on ad spend changes by more than a threshold amount when each one of them is individually removed from the analysis.

The returns on ad spend are re-calculated by removing each geographic region in turn, and always omitting Chicago, Denver, and New York. The resulting returns on ad spend are plotted in histogram 408. As can be seen from a comparison of the two histograms, the removal of Chicago, Denver, and New York results in a more consistent, e.g., tighter, distribution of returns on ad spend.

§4.0 Example Processes for Selecting Experiment Parameters

The execution and analysis described above in §2.0 and §3.0 rely on several experiment parameters. These experiment parameters can include, for example, the change in ad spend policy that determines the amount of money spent in each geographic region, the length of the test period, the algorithm used to select the treatment and control clusters, and which geographic regions are included in the experiment. In some implementations, the system 100 selects one or more of these experiment parameters according to one or more of experiment constraints, geographic region data, and pre-spend data. An example process for selecting a change in ad spend policy for each geographic region is described below in §4.1. An example process for selecting a technique used to specify control and treatment clusters is described below in §4.2. An example process for determining which geographic regions should be included in an experiment is described below in §4.3.

§4.1 Example Process for Selecting Change in Ad Spend in Each Geographic Region

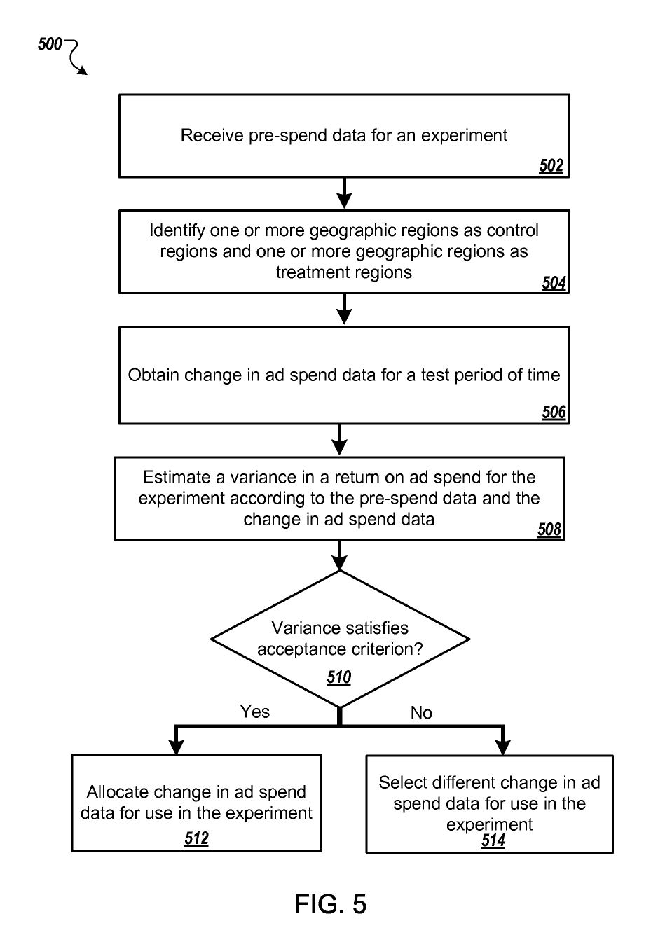

FIG. 5 is a flow diagram of an example process 500 for selecting a change in ad spend policy for treatment and control regions. The process 500 is performed before an advertising experiment is performed, in order to determine one or more appropriate parameters for the advertising experiment. The process 500 can be implemented, for example, by the system 100, described above with reference to FIG. 1.

The process 500 receives pre-spend data for an experiment (502). The pre-spend data quantifies an action of interest related to the advertising campaign being tested by the experiment, as described above with reference to FIG. 1. The process identifies one or more of the geographic regions as control regions and one or more of the geographic regions as treatment regions (504). This identification can be made according to one of various heuristics, as described in more detail below in §4.2.

The process 500 obtains change in ad spend data for a test period of time for each geographic region (506). The change in ad spend data specifies a change in ad spend for each geographic region during the test period of time. The change in ad spend is the difference in the ad spend during the test period of time as compared to what the change in ad spend would have been during the test period of time if a change in ad spend policy had not been adopted. The change in ad spend in each control region is determined according to a change in ad spend policy for the control regions, and the change in ad spend in each treatment region is determined according to a change in ad spend policy for each of the treatment regions. In some implementations, the change in ad spend policy for a region specifies a specific amount that the ad spend should change during the test period. For example, the change in ad spend policy can specify that the amount of money spent should be derived from the pre-test data for the treatment region. For example, the process 500 can multiply a factor specified by the change in ad spend policy by the quantification of the action of interest in the pre-spend region, or the pre-spend data for the region to determine the change in ad spend for the region. For example, if the pre-spend data quantifies a volume of sales in the region, the change ad spend can be determined to be 10% of the sales. Different factors will result in different change in ad spend decisions for each treatment region. Other data can also be used, for example, total sales in a region. Different factors can be used for the control and treatment change in ad spend policies.

In some implementations, the change in ad spend policy for a region, e.g., the control regions, specifies that the change in ad spend will be zero.

In other implementations, the change in ad spend policy for a region does not specify a specific change in money spent on advertising, but instead specifies changes in the policy used to determine when, and how much, to pay for advertising. For example, if the advertiser pays for advertisements triggered on certain keywords, the change in ad spend policy can specify a change in the keywords that will trigger the advertisements. As another example, if the advertiser pays a certain amount each time an advertisement is displayed, or each time an advertisement is clicked on, the change in ad spend policy can specify a change in the amount paid, or a change in the maximum amount that will be paid, for each display or click. As another example, the change in ad spend policy can specify a cap on the budget, e.g., how much an advertiser will pay in total for advertisements during a certain period during the test.

In these implementations, the process 500 obtains the change in ad spend data by estimating the change in ad spend that will result from the change in ad spend policy. For example, if the change in ad spend policy adds a new keyword to the keywords that will trigger the advertisement, the process 500 obtains the change in ad spend data by estimating how many additional times the advertisement will be shown as a result of that change, and the expected cost each time the advertisement is shown. As another example, if the change in ad spend policy specifies a change in the amount paid for each advertisement shown, the process 500 obtains the change in ad spend data by estimating the number of times the advertisement will be shown during the test period, and multiplying that by the increased cost of displaying each advertisement. As yet another example, if the change in ad spend policy specifies a change in the maximum amount paid for each advertisement shown, the process 500 obtains the change in ad spend data by estimating the number of times the advertisement will be shown during the test period and multiplying that by the expected increase in cost of displaying each advertisement.

The process 500 estimates a variance in a return on ad spend for the experiment according to the pre-spend data and the change in ad spend data (508). The process 500 estimates the variance in the return on ad spend from a variance in the change in ad spend data and a correlation between the pre-spend data and the change in ad spend data.

The variance is estimated based on the model that will be used to determine the return on ad spend. For example, when a linear regression model:

(test data)β₀+β₁(pre-test data)+β₂(change in ad spend)+ε,

such as the linear regression model described above in §3.1 is used to determine the return on ad spend, the variance of β₂ can be estimated according to the following equation:

$$var ( {β}_{2} ) = \frac{{σ}_{ɛ}^{2}}{( n - 1 ) {s}_{z}^{2}} ( \frac{1}{1 - {ρ}^{2}} ) ,$$

where σ_{ε}² is the variance of ε, n is the number of geographic regions used in the experiment, s_{Z}² is the sample variance of the change in ad spend in each geographic region, and ρ is the correlation between the pre-spend data and the ad test data.

To calculate the values used in the equation, the process 500 divides the pre-spend data into two subsets, pseudo pre-spend data and pseudo test data, to mimic an experiment where no change in ad spend was observed. For example, if the pre-spend data includes data for each week of the pre-spend period, the process 500 can divide the pre-spend data in half according to time, where the data for the first half of the weeks is the pseudo-pre-spend data, and the data for the second half of the weeks is the pseudo-test data. The process 500 can then fit the following model to estimate σ_{ε}:

(pseudo-test data)˜β₀+β₁(pseudo-pre-test data)+ε.

After the process 300 fits β₀, β₁, and ε, the process calculates the sample variance of ε, s_{ε}², and estimates the variance σ_{ε}² of ε according to the following equation:

$${σ}_{ɛ}^{2} = \frac{{m}_{1}^{′}}{{m}_{1}} {s}_{ɛ}^{2} ,$$

where m′₁ is the actual length of the experiment in weeks, days, or some other measure of time, where the length of the experiment includes both the spend period and the post-spend period, and m₁ is the length of the pseudo-test data in weeks, days, or some other measure of time.

The process 500 estimates the change in ad spend in each geographic region by first selecting some of the geographic regions as control geographic regions and some of the geographic regions as treatment geographic regions, according to a control and treatment determination heuristic. The process 500 then determines the change in ad spend in each region according to the control region change in ad spend policy and the treatment region control in ad spend policy. The process can then calculate the sample variance of the change in ad spend from the estimated change in ad spend for each geographic region.

In some implementations, the heuristic used to select treatment and control geographic regions includes some randomness. In these implementations, the process 500 can repeat the steps above multiple times and then calculate the mean of the variance resulting from each repetition. This mean variance can be used as the variance for the return on ad spend.

The process 500 determines whether the variance satisfies an acceptance criterion (510). Various acceptance criteria can be used. For example, in some implementations, the process 300 compares the variance to a variance threshold. The variance threshold is the maximum acceptable variance for the experiment and can be specified, for example, in the experiment constraints 110. In some implementations, the acceptance criterion is satisfied when the variance is less than a second variance for a different change in ad spend. The system can calculate the second variance for the different change in ad spend, for example, as described above. The different change in ad spend can be determined in different ways. For example, a different factor k can be used to determine the change in ad spend from the pre-spend data, or another different change in ad spend policy can be used.

If the variance satisfies an acceptance threshold, the process 500 allocates the change in ad spend data for use in the advertising experiment (512). The system can either perform the advertising experiment itself, or provide the change in ad spend data to another system that performs the experiment.

If the variance does not satisfy the acceptance threshold, the process 500 selects different change in ad spend data for use in the advertising experiment. For example, the process 500 can repeat with a different change in ad spend.

In some implementations, the process 500 additionally or alternatively determines the length of the experiment, for example, by varying the length of the spend period or the post-spend period when estimating the variance.

§4.2 Example Process for Selecting a Control/Treatment Determination Heuristic

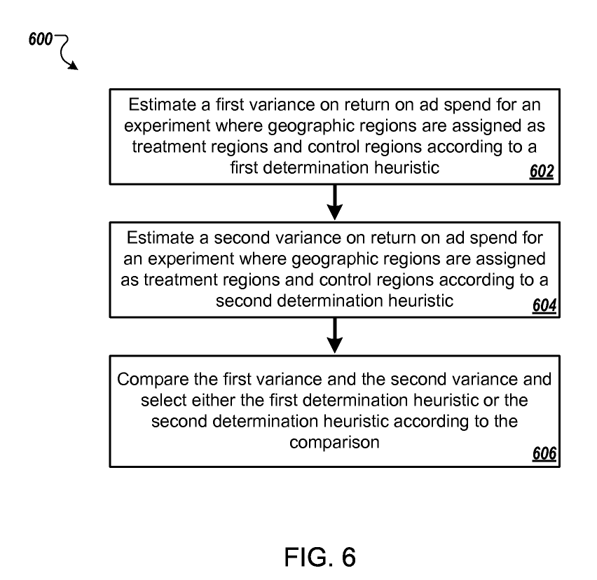

FIG. 6 is a flow diagram of an example process 600 for selecting a control and treatment region determination heuristic for use in an advertising experiment. The process 600 can be implemented, for example, by the system 100, described above with reference to FIG. 1.

The process 600 compares different heuristics for selecting control and treatment regions. In general, each heuristic specifies how to determine which geographic regions should be control regions and which geographic regions should be treatment regions. One example heuristic is an unconstrained random assignment, in which geographic regions are selected as treatment and control regions at random.

Other example heuristics match pairs, or larger groups, of geographic regions according to one or more attributes, and then randomly select one of the matched geographic regions as a treatment geographic region and the other of the matched geographic regions as a control geographic region (or half as treatment and half as control, when the groups contain more than two regions). Matching heuristics rank geographic regions according to the one or more attributes, and then pair, or group, geographic regions that are next to each other in the ranking For example, if there are six geographic regions, a matching heuristics could match the first and second geographic regions, match the third and fourth geographic regions, and match the fifth and sixth geographic regions. Various attributes of the geographic regions can be used. For example, one or more of the quantification of the action of interest in each geographic region, the longitudinal location of the geographic region, the physical size of the geographic region, the minimum, maximum, or average distance between subjects in the region and a physical store selling products advertised by the advertisement, demographic attributes of the subjects living in the region, e.g., age, income, sex, race, and other demographic characteristics, or social network data, can be used.

The process 600 estimates a first variance on a return on ad spend for an experiment where geographic regions are assigned as treatment regions and control regions according to a first determination heuristic (602), for example, using the process described above with reference to FIG. 5. The process 600 estimates a second variance on a return on ad spend for an experiment where geographic regions are assigned as treatment regions and control regions according to a second determination heuristic (604), for example, using the process described above with reference to FIG. 5. The process 600 compares the first variance and the second variance, and selects either the first determination heuristic or the second determination heuristic according to the comparison (606). For example, the process 600 can select the determination algorithm having the lower variance.

§4.3 Identifying Outlying Geographic Regions

In some implementations, the system identifies one or more geographic regions that should not be included in the experiment, because they introduce an undesired amount of variance into the experiment.

The system can consider either the estimated value of the return on ad spend β₂, or the value of one of the seasonality parameters β₀ and β₁. The system considers each geographic region in turn and calculates the value of one of the parameters β₀, β₁, or β₂, using the data for all of the geographic regions except the geographic region being considered. The system then compares the calculated values to identify one or more geographic regions that are outliers. A geographic region is an outlier if the value calculated without the geographic region differs from the other calculated values by more than a threshold amount. For example, the threshold could be a value that is more than the ninety-fifth percentile or less than the fifth percentile of the calculated values.

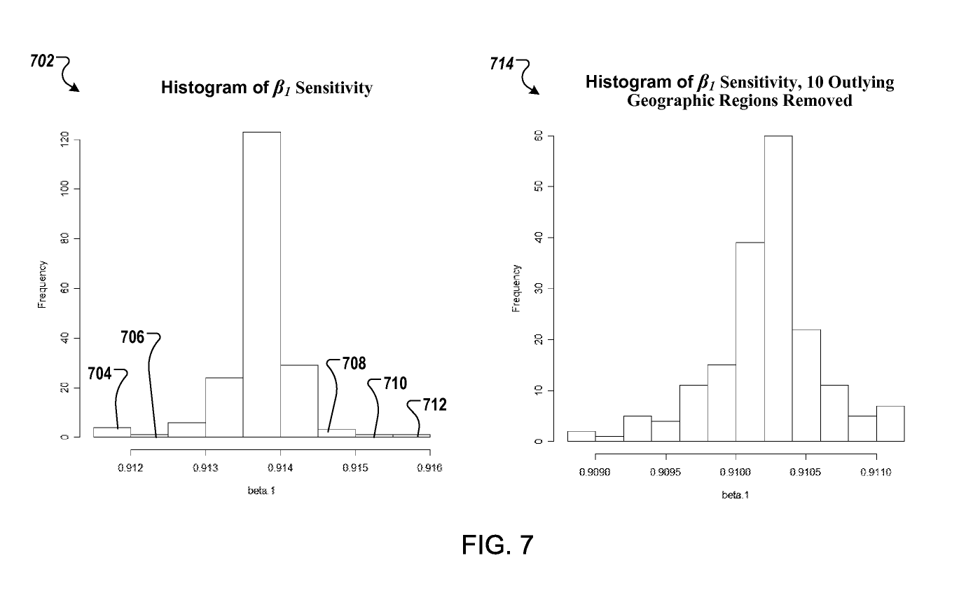

FIG. 7 illustrates two example histograms of values of the β₁ parameter. In histogram 702, the values calculated by individually removing each geographic region in turn are plotted, and outlying values are identified. For example, the values in bin 704 and 706 on the left side of the histogram are outlying values. These values correspond to values calculated after the individual removal of Dallas, Tex., Denver, Colo., New York, N.Y., and San Francisco, Calif. Similarly, the values in bins 708, 710, and 712 on the right side of the histogram are outlying values. These outlying values correspond to values calculated after the individual removal of Billings, Montana, Little Rock, Arkansas, New Orleans, La., Tampa, Fla., and Detroit, Mich. Therefore, Dallas, Denver, New York, San Francisco, Billings, Little Rock, New Orleans, Tampa, and Detroit are outlying geographic regions.

The values are re-calculated by removing each geographic region in turn, and always omitting the outlying geographic regions of Dallas, Denver, New York, San Francisco, Billings, Little Rock, New Orleans, Tampa, and Detroit. The resulting values are plotted in histogram 714. As can be seen from a comparison of the two histograms, the removal of the outlying geographic regions results in a more consistent distribution of the value.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving pre-spend data for an experiment for an advertising campaign, the pre-spend data specifying, for each of a plurality of geographic regions, a quantification of an action of interest related to the advertising campaign in the geographic region during a pre-spend period of time;
identifying one or more of the geographic regions as first control geographic regions and one or more of the geographic regions as first treatment geographic regions according to a first determination algorithm;
obtaining first change in ad spend data for a test period of time, the first change in ad spend data specifying an estimated first change in ad spend for each of the geographic regions, wherein the estimated first change in ad spend is a difference in ad spend in the geographic region during a test period of time occurring after the pre-spend period of time and ad spend in the geographic region during the pre-spend period of time, wherein the estimated first change in ad spend is determined according to a first change in ad spend policy for each first control geographic region and the estimated first change in ad spend is determined according to a second change in ad spend policy for each first treatment geographic region;
estimating a first variance in a return on ad spend for the experiment according to the pre-spend data and the first change in ad spend data, wherein the first variance is estimated from a variance of the first change in ad spend data and a correlation between the pre-spend data and the first change in ad spend data; and
determining whether the first variance satisfies an acceptance criterion, allocating the first change in ad spend data for use in an advertising experiment if the first variance satisfies an acceptance criterion, and otherwise selecting different change in ad spend data for use in the advertising experiment.

2. The method of claim 1, wherein the acceptance criterion is satisfied if the first variance satisfies a threshold.

3. The method of claim 1, further comprising:
obtaining second change in ad spend data for the test period of time, the second change in ad spend data specifying an estimated second change in ad spend for each of the geographic regions;
estimating a second variance in a return on ad spend for the experiment according to the pre-spend data and the second change in ad spend data; and
wherein the acceptance criterion is satisfied if the first variance is lower than the second variance.

4. The method of claim 1, wherein the change in ad spend for each of the treatment geographic regions is derived from the pre-spend data for the region.

5. The method of claim 1, wherein the first change in ad spend is zero for each first control geographic region and the first change in ad spend is non-zero for each first treatment geographic region.

6. The method of claim 1, further comprising:
identifying one or more of the geographic regions as second control geographic regions and one or more of the geographic regions as second treatment geographic regions according to a second determination algorithm;
obtaining second change in ad spend data for a test period of time, the second change in ad spend data specifying an estimated second change in ad spend for each of the geographic regions, wherein the estimated second change in ad spend is determined according to a third change in ad spend policy for each second control geographic region and the estimated second change in ad spend is determined according to a different fourth change in ad spend policy for each second treatment geographic region;
estimating a second variance in a return on ad spend for the experiment according to the pre-spend data and the second change in ad spend data, wherein the second variance is estimated from a variance of the second ad test data and a correlation between the pre-spend data and the second change in ad spend data; and
comparing the first variance to the second variance and selecting the first determination algorithm or the second determination algorithm as a result of the comparison.

7. The method of claim 6, wherein the first change in ad spend is zero for each first control geographic region, the first change in ad spend is non-zero for each first treatment geographic region, the second change in ad spend is zero for each second control geographic region, and the second change in ad spend is non-zero for each second treatment geographic region.

8. The method of claim 1, further comprising obtaining a length of the experiment, wherein the first variance is further estimated according to the length of the experiment.

9. The method of claim 1, wherein the quantification of the action of interest in a geographic region is a total amount of revenue earned as a result of sales of a product in the geographic region, wherein the product is a product advertised by the advertising campaign.

10. The method of claim 1, wherein the quantification of the action of interest in a geographic region is a total amount of revenue earned as a result of sales of a product in the geographic region, wherein the product is a product related to, but not directly advertised by, the advertising campaign.

11. The method of claim 1, wherein the quantification of the action of interest in a geographic region is a total number of clicks on a website made by subjects in the geographic region.

12. A computer-implemented method performed by one or more data processing apparatus, the method comprising:
receiving pre-spend data for each of a plurality of geographic regions, the pre-spend data including pre-spend data quantifying an action of interest related to a particular advertising campaign in the geographic region during a pre-spend period of time;
identifying one or more of the geographic regions as control geographic regions and one or more of the geographic regions as treatment geographic regions;
determining a change in ad spend policy for the particular advertising campaign for each geographic region, wherein the change in ad spend policy specifies how ad spend in the geographic region during a test period of time occurring after the pre-spend period of time should be changed, wherein the ad spend policy in each control geographic region is a first ad spend policy and the change in ad spend policy in the second geographic region is a different second ad spend policy;
receiving test data for each of the plurality of geographic regions, wherein the test data corresponds to a test period of time during which the particular advertising campaign was run and the test data quantifies the action of interest in the geographic region during the test period of time;
determining an experimental change in ad spend for each geographic region, wherein the experimental change in ad spend for a geographic region specifies a difference in an actual ad spend in the geographic region during the test period of time as compared to what ad spend in the geographic region during the test period of time would have been without the change in ad spend policy for the geographic region;
fitting a model to the pre-spend data, the experimental change in ad spend, and the test data, wherein the model models the test data for each geographic region as a function of the pre-spend data and the change in ad spend for each geographic region, and wherein fitting the model includes determining one or more parameters of the function; and
determining a return on ad spend from the fitted model.

13. The method of claim 12, wherein the change in ad spend is zero in each control geographic region and is non-zero in each treatment geographic region.

14. The method of claim 12, wherein the model is a linear regression model.

15. The method of claim 14, wherein the one or more parameters of the function include one or more seasonality parameters and a return on ad spend parameter.

16. The method of claim 15, wherein one of the one or more seasonality parameters is multiplied by the pre-spend data in the function and the return on ad spend parameter is multiplied by the change in ad spend in the function.

17. The method of claim 12, wherein the quantification of the action of interest is a quantification of sales of a product advertised by the advertising campaign.

18. The method of claim 17, wherein the sales of the product are one of in-store sales, online sales, and both in-store sales and online sales.

19. The method of claim 12, wherein the quantification of the action of interest is a number of clicks on a website associated with the advertising campaign.

20. The method of claim 12, further comprising:
for each geographic region:
re-fitting the model using data for each of the plurality of geographic regions except the geographic region, and determining a return on ad spend from the fitted model;
determining whether the geographic region is an outlying geographic region from the determined return on ad spend; and
re-fitting the model using data for each of the plurality of geographic regions except the geographic regions identified as outlying geographic regions.

21. A system comprising:
a processor; and
a computer storage medium coupled to the processor and including instructions, which, when executed by the processor, cause the processor to perform operations comprising:
receiving pre-spend data for an experiment for an advertising campaign, the pre-spend data specifying, for each of a plurality of geographic regions, a quantification of an action of interest related to the advertising campaign in the geographic region during a pre-spend period of time;
identifying one or more of the geographic regions as first control geographic regions and one or more of the geographic regions as first treatment geographic regions according to a first determination algorithm;
obtaining first change in ad spend data for a test period of time, the first change in ad spend data specifying an estimated first change in ad spend for each of the geographic regions, wherein the estimated first change in ad spend is a difference in ad spend in the geographic region during a test period of time occurring after the pre-spend period of time and ad spend in the geographic region during the pre-spend period of time, wherein the estimated first change in ad spend is determined according to a first change in ad spend policy for each first control geographic region and the estimated first change in ad spend is determined according to a different second change in ad spend policy for each first treatment geographic region;
estimating a first variance in a return on ad spend for the experiment according to the pre-spend data and the first change in ad spend data, wherein the first variance is estimated from a variance of the first change in ad spend data and a correlation between the pre-spend data and the first change in ad spend data; and
determining whether the first variance satisfies an acceptance criterion, allocating the first change in ad spend data for use in an advertising experiment if the first variance satisfies an acceptance criterion, and otherwise selecting different change in ad spend data for use in the advertising experiment.

22. The system of claim 21, further operable to perform operations comprising:
obtaining second change in ad spend data for the test period of time, the second change in ad spend data specifying an estimated second change in ad spend for each of the geographic regions;
estimating a second variance in a return on ad spend for the experiment according to the pre-spend data and the second change in ad spend data; and
wherein the acceptance criterion is satisfied if the first variance is lower than the second variance.

23. The system of claim 21, further operable to perform operations comprising:
identifying one or more of the geographic regions as second control geographic regions and one or more of the geographic regions as second treatment geographic regions according to a second determination algorithm;
obtaining second change in ad spend data for a test period of time, the second change in ad spend data specifying an estimated second change in ad spend for each of the geographic regions, wherein the estimated second change in ad spend is determined according to a third change in ad spend policy for each second control geographic region and the estimated second change in ad spend is determined according to a different fourth change in ad spend policy for each second treatment geographic region; and
estimating a second variance in a return on ad spend for the experiment according to the pre-spend data and the second change in ad spend data, wherein the second variance is estimated from a variance of the second ad test data and a correlation between the pre-spend data and the second change in ad spend data; and
comparing the first variance to the second variance and selecting the first determination algorithm or the second determination algorithm as a result of the comparison.

24. The system of claim 21, wherein the first change in ad spend is zero for each first control geographic region and the first change in ad spend is non-zero for each first treatment geographic region.

25. A system comprising:
a processor; and
a computer storage medium coupled to the processor and including instructions, which, when executed by the processor, cause the processor to perform operations comprising:
receiving pre-spend data for each of a plurality of geographic regions, the pre-spend data including pre-spend data quantifying an action of interest related to a particular advertising campaign in the geographic region during a pre-spend period of time;
identifying one or more of the geographic regions as control geographic regions and one or more of the geographic regions as treatment geographic regions;
determining a change in ad spend policy for the particular advertising campaign for each geographic region, wherein the change in ad spend policy specifies how ad spend in the geographic region during a test period of time occurring after the pre-spend period of time should be changed;
receiving test data for each of the plurality of geographic regions, wherein the test data corresponds to a test period of time during which the particular advertising campaign was run and the test data quantifies the action of interest in the geographic region during the test period of time;
determining an experimental change in ad spend for each geographic region, wherein the experimental change in ad spend for a geographic region specifies a difference in an actual ad spend in the geographic region during the test period of time as compared to what ad spend in the geographic region during the test period of time would have been without the change in ad spend policy for the geographic region;
fitting a model to the pre-spend data, the experimental change in ad spend, and the test data, wherein the model models the test data for each geographic region as a function of the pre-spend data and the change in ad spend for each geographic region, and wherein fitting the model includes determining one or more parameters of the function; and
determining a return on ad spend from the fitted model.

26. The system of claim 25, wherein the model is a linear regression model and one or more parameters of the function include a seasonality parameter that is multiplied by the pre-spend data in the function and a return on ad spend parameter that is multiplied by the change in ad spend in the function.

27. The system of claim 26, further operable to perform operations comprising:
for each geographic region:
re-fitting the model using data for each of the plurality of geographic regions except the geographic region, and determining a return on ad spend from the fitted model; and
determining whether the geographic region is an outlying geographic region from the determined return on ad spend; and
re-fitting the model using data for each of the plurality of geographic regions except the geographic regions identified as outlying geographic regions.
